(19) United States
(12) Patent Application Publication
(10) Pub. No.: US 2003/0177094 A1
(43) Pub. Date: Sep. 18, 2003

(54) Authenticatable positioning data

(76) Inventors: Bradford H. Needham, North Plains, OR (US); David J. Cowperthwaite, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/099,395

(22) Filed: Mar. 15, 2002

(51) Int. Cl. G06F 17/60

(52) U.S. Cl. 705/50

(57) ABSTRACT

To facilitate an offeror making sensible offers to offerees based on locations visited by offerees, position data from a positioning device, such as a GPS or other positioning device, is digitally signed or encrypted, and provided to an offeror. The offeror may then validate the digitally signed or encrypted position data before extending an offer based thereon. To facilitate digital signing or encryption of position data, an encryption key may be embedded within a positioning device by a manufacture of the positioning device. Various trust models may be employed between the manufacturer, offeror and offerees.

### FIELD OF THE INVENTION

The invention generally relates to authenticating positioning data, such as Global Positioning System (GPS) data, and more particularly to digitally signing positioning data to facilitate determining authenticity of the data.

### BACKGROUND

Availability of low-cost position determination devices, such as inexpensive GPS receivers, has brought such devices into the hand of general consumers. This has resulted in attempts to leverage the use of such receivers. For example, one such use is to provide offers of goods or services to people that can provide a “track log,” e.g., recorded output from a positioning device, that indicates that one has visited a certain location or otherwise qualified for an offer. Unfortunately, a significant limitation to making such offers based on a track log is that one may fraudulently alter a track log so as to inappropriately qualify for the offer.

### BRIEF DESCRIPTION OF THE DRAWINGS

The features and advantages of the present invention will become apparent from the following detailed description of the present invention in which:

FIG. 1 illustrates an exemplary positioning device.

FIG. 2 illustrates a system-level data-flow diagram according to one embodiment of the invention utilizing the FIG. 1 positioning device.

FIG. 3 illustrates a variation of the FIG. 2 embodiment according to one embodiment of the invention.

FIG. 4 illustrates a suitable computing environment in which certain aspects of the invention may be implemented.

### DETAILED DESCRIPTION

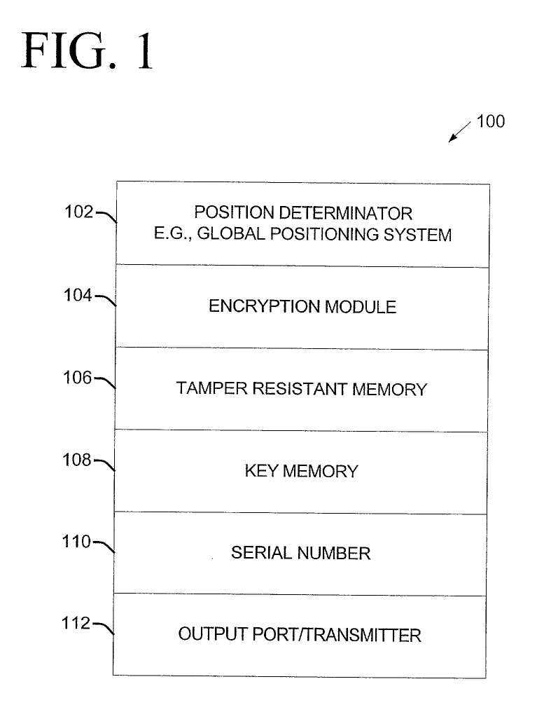

FIG. 1 illustrates an exemplary positioning device 100. In one embodiment, the positioning device comprises a global positioning system (GPS) detector 102 that operates to obtain geographic location information, hereafter simply “position data,” according to known methods of receiving and interpreting GPS signals. It will be appreciated by one skilled in the art that other position detection technology, e.g., long-range radio navigation (LORAN), Inertial Navigation Systems (INS), etc. may also be used to determine position data.

As illustrated, the positioning device also comprises an encryption module 104. The encryption module may be used to encrypt and/or sign position data determined by the GPS, e.g., to encrypt a GPS track log or other position related output from the GPS, using known public key or secret key cryptographic techniques, including block or stream ciphers, hash functions, RSA, Digital Signature Algorithm (DSA), Diffie-Hellman, Data Encryption Standard (DES), MD2, MD4, MD5, and public key cryptography techniques. The encryption module may be implement in software, firmware, or hardware. When the encryption module is implemented in software, the encryption module may be protected from tampering by using known tamper resistant software techniques. In one embodiment, tamper resistant memory 106 is used to store program instructions, processor directives, or the like, for the positioning device.

In one embodiment, the encryption module 104 digitally signs position data determined by the GPS 102. In another embodiment, the encryption module encrypts position data into unrecognizable cipher text. In one embodiment, the encryption module digitally signs or encrypts only a portion of position data determined by the GPS. In another embodiment, all position data output from the GPS is digitally signed or encrypted as it is determined by the GPS.

In the illustrated embodiment, the positioning device 100 also comprises a key memory 108 communicatively coupled with the GPS 102 and encryption module 104; the key memory may be permanently affixed to the positioning device, or removably coupled, such as by way of an insertable identification card or the like. The memory may be used to store an encryption key, such as a private key from a pair of asymmetric keys used in a public key cryptosystem, and the memory may be tamper resistant. In one embodiment, the positioning device has an associated serial number 110 that corresponds to a public key which may be used to validate a signature applied with the private key, or to decode data encrypted with the private key. It will be appreciated that the serial number may be encoded in memory and/or affixed to a casing enclosing the positioning device 100. In one embodiment, the tamper resistant memory 106 and the key memory 108 are a single memory.

In one embodiment, the manufacturer of the positioning device 100 writes the encryption key, e.g., the private key, into the key memory 108. The manufacturer then, in essence, acts as a certificate authority (CA) in this security system. A certificate authority issues certificates, which are cryptographically secured data files that identify an entity, such as the manufacturer, that often describe various attributes of the entity, and enable the identified entity to digitally sign or encrypt data such that a signature is traceable back to the entity. In another embodiment, a different entity (not illustrated) acts as a certificate authority in this security system, and the certificate authority provides the manufacturer with the encryption key, e.g., the private key, for storing in the key memory 108.

In the illustrated embodiment, the positioning device 100 also comprises an output 112 for providing data, including signed or encrypted position data, from the positioning device to a destination external to the positioning device. It will be appreciated that any form of wired or wireless carrier or network technology may be used to communicate data from the output to the destination.

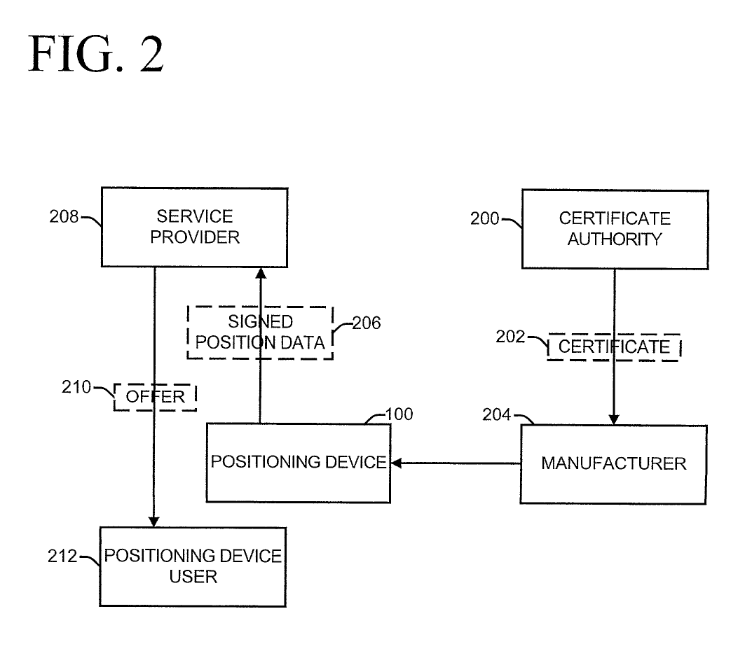

FIG. 2 illustrates a system-level data-flow diagram according to one embodiment of the invention utilizing the FIG. 1 positioning device 100. As illustrated, a certificate authority 200 sends a manufacturers certificate 202 to a manufacturer 204 of the positioning device.

The manufacturer 204 may then in turn store the certificate 202 in the key memory 108 so that the positioning device 100 is enabled to digitally sign or encrypt position data. In another embodiment, rather storing a certificate 202 in the memory, instead the manufacturer derives a cryptographic key pairing comprising a public key and a private key based on the certificate, and the private key is stored in the memory. In this latter embodiment, a manufacturer is able to uniquely identify each manufactured device based on the cryptographic key(s) associated with the manufactured device. The key pairing may be derived with respect to the certificate. In one embodiment, the positioning device may be configured such that it operates without signing or encryption capabilities when no certificate or other cryptographic key is present in the key memory.

Signed position data 206 may then be provided to a service provider 208, which in turn may review the signed position data and make offers 210, e.g., to an entity 212 such as a user (assumed for the purposes of this description) or business owning or otherwise responsible for the positioning device 100. Typically, a service provider is interested in making an offer to users that have been to certain locations that meet offer requirements. For example, in one embodiment, the service provider may want to issue a discount coupon to users known to have frequented a competitor's store. In a further embodiment, the value or nature of the coupon or other offer may be partially or wholly dependent on various factors, such as the frequency of visits to the competitor's store, or the type of other destinations visited by the user. However, before committing to a particular offer, the service provider often wants to validate that a particular user has in fact visited locations meeting the terms of an offer.

There are various ways to validate a user. For example, if received position data is unencrypted, and appears to satisfy the terms of an offer, the service provider validates the digital signature applied to the position data to ensure that the position data has not been tampered with to satisfy the offer. If the position data appears legitimate, then the service provider may comfortably extend an offer. It will be appreciated that if the position data is encrypted, if it can be successfully decrypted, then this can be viewed as validating the position data, allowing an offer to be extended.

Once position data, e.g., a GPS track log or other data representing travels, can be verified, many uses of the invention are possible. One such use is defining private clubs based on members having visited certain places, or members having visited certain places within a particular time frame. Another use is, as discussed above, providing special offers for goods, services, coupons, etc., depending on where the position data indicates one has been, e.g., to a competitor's store.

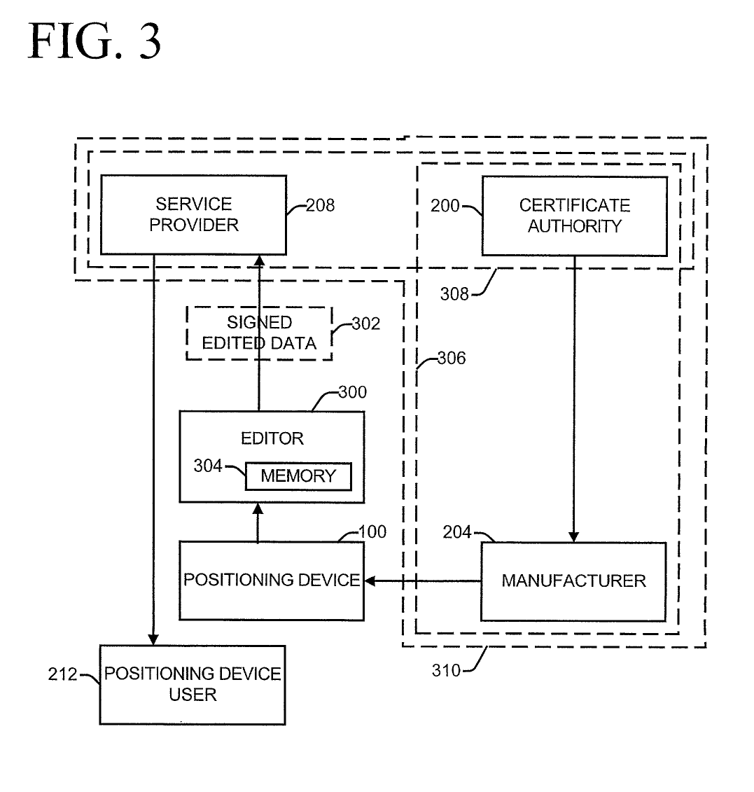

FIG. 3 illustrates a variation of the FIG. 2 embodiment. As illustrated, an editor 300 is communicatively coupled between the positioning device and the service provider 208. In this embodiment, the editor receives a certificate 302, e.g., an editor's certificate, from the certificate authority and stores it in a key memory 304 in a manner analogous to that discussed above with respect to the FIG. 1 key memory 108.

The editor 300 may then be used to edit position data 206 signed by the positioning device 100, and then sign the edited data to allow confirmation by the service provider 208 or other entity that the output from the editor was not tampered with or otherwise altered. One reason for such editing would be to remove portions from position data not related to satisfying an offer. That is, the editor could determine that the output from the positioning device had not been tampered with, remove unnecessary position data, resign the edited position data, and provide the edited position data to the service provider 206. Another reason would be to afford privacy, or to comply with privacy policies or other policies or interests of the user 212.

By validating the data from the positioning device, the editor addresses the issue of where position data goes to an illicit third party that improperly modifies the position data and then sends it to the editor for signing. In one embodiment, chain of custody information is available to allow a service provider to determine and confirm what entity took what action on the position data.

It will be appreciated that although both FIGS. 2 and 3 illustrate the positioning device 100, certificate authority 200, manufacturer 204, service provider 208, user 212, and editor 300 as separate entities, various other entity combinations may be utilized. For example, as illustrated by the dotted lines, the certificate authority and manufacturer may comprise a single entity 306, or the certificate authority and the service provider may comprise a single entity 308, or all three may comprise a single entity 310.

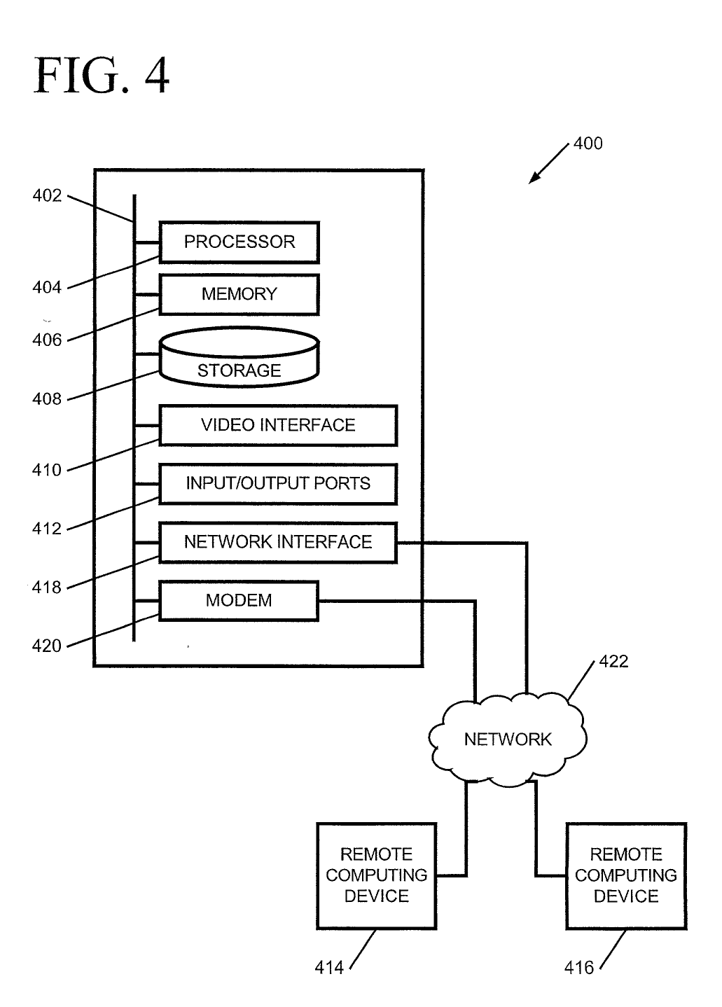

FIG. 4 and the following discussion are intended to provide a brief, general description of a suitable computing environment in which certain aspects of the illustrated invention may be implemented.

An exemplary environment for embodying, for example, the positioning device 100 of FIG. 1 or the certificate authority 200 of FIG. 2, includes a machine 400 having system bus 402. As used herein, the term “machine” includes a single machine or a system of communicatively coupled machines. Typically, attached to the bus are processors 404, a memory 406 (e.g., RAM, ROM), storage devices 408, a video interface 410, and input/output interface ports 412. The machine 400 may be controlled, at least in part, by input from conventional input devices, such as keyboards, mice, joysticks, as well as directives from another machine, biometric feedback, e.g., data incident to monitoring a person, plant, animal, organism, etc., or other input.

The system may also include embedded controllers, such as Generic or Programmable Logic Devices or Arrays, Application Specific Integrated Circuits, single-chip computers, smart cards, or the like. The system is expected to operate in a networked environment using physical and/or logical connections to one or more remote machines 414, 416 through a network interface 418, modem 420, or other data pathway. Collectively, the input/output ports 412 and connections 418, 420 comprise exemplary embodiments for the output 112 of FIG. 12. The machines may be interconnected by way of a wired and/or wireless network 422, such as an intranet, the Internet, local area networks, wide area networks, cellular, cable, laser, satellite, microwave, “Bluetooth” type networks, optical, infrared, or other short range or long range wired or wireless carrier.

The invention may be described by reference to or in conjunction with program modules, including functions, procedures, data structures, application programs, etc. for performing tasks, or defining abstract data types or low-level hardware contexts. Program modules may be stored in memory 406 and/or storage devices 408 and associated storage media, e.g., hard-drives, floppy-disks, optical storage, magnetic cassettes, tapes, flash memory cards, memory sticks, digital video disks, biological storage. Program modules may be delivered over transmission environments, including network 422, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Thus, for example, with respect to the illustrated embodiments, assuming machine 400 operates as the positioning device 100, then remote machines 414, 416 may respectively be a FIG. 2 certificate authority 200 and a service provider 206. It will be appreciated that remote machines 414, 416 may be configured like machine 400, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A positioning device to output digitally signed position data to be communicated to a service provider offering goods or services based at least in part on digitally signed position data, the device comprising:
a position identifier configured to determine position data based at least in part on receiving signals from one or more signal sources;
an encryption module configured to digitally sign the position data; and
an output for outputting digitally signed position data

2. The device of claim 1, further comprising:
an input for receiving an offer from the service provider.

3. The device of claim 1, wherein the encryption module is further configured to sign the position data with a private key of an asymmetric key pair.

4. The device of claim 3, wherein the private key is embedded within the device.

5. The device of claim 4, wherein the private key is provided to a manufacturer of the device which embeds the private key within the device.

6. The device of claim 1, further comprising:
an interface to an editor communicatively coupled to the device, the editor configured to allow position data to be modified and digitally sign such edits.

7. The device of claim 6, wherein the editor digitally signs such edits with a private key of an asymmetric key pair.

8. The device of claim 6, wherein edits to position data are made according to a privacy policy.

9. The device of claim 6, wherein to protect the privacy of a user of the device, position data is edited to leave only portions required to meet requirements of an offer of the service provider.

10. The device of claim 1, wherein position data and digital signatures for position data are stored in a structured data file having a first portion storing position data, and a second portion storing a digital signature for the position data in the first portion.

11. A system comprising:
a positioning device manufacturer configured to receive a first private key of an asymmetric key pair and to embed the first private key within a positioning device configured to sign position data determined by the positioning device with the first private key; and
a service provider communicatively coupled to the positioning device and configured to receive signed position data from the positioning device, validate its authenticity with a public key associated with the first private key, and offer goods or services based at least in part on the positioning data.

12. The system of claim 11, wherein the service provider is configured to make a first offer if the signed position data can be validated with the public key, and to make a second offer if the signed position data cannot be validated.

13. The system of claim 11, further comprising:
a certificate authority configured to manage at least the private keys of asymmetric key pairs, said managing including providing the private key to the positioning device manufacturer for embedding within the positioning device.

14. The system of claim 13, further comprising:
an editor configured to receive a second private key from the certificate authority, edit position data determined by the positioning device, and sign edited position data with the second private key.

15. The system of claim 11, further comprising:
an editor communicatively coupled to the positioning device, the edit or configured to edit position data determined by the positioning device and to sign edited position data with a second private key associated with the editor.

16. A method comprising:
determining a position data with a positioning device;
digitally signing the position data with an encryption module within the positioning device;
providing the digitally signed position data to a service provider configured to extend offers based on digitally signed position data.

17. The method of claim 16, wherein the position data is digitally signed with respect to a private key of an asymmetric key pair.

18. The method of claim 16, further comprising:
receiving terrestrial signal broadcasts and determining the position data responsive thereto.

19. The method of claim 16, wherein the positioning device is disposed within a transportation vehicle.

20. The method of claim 16, further comprising:
receiving, responsive to providing the digitally signed position data, an offer.

21. A method of manufacturing a positioning device, comprising:
manufacturing a positioning device comprising a memory for storing an encryption key; and
configuring the positioning device to allow position data to be signed with the encryption key if the encryption key has been stored in the memory.

22. The method of claim 21, further comprising:
receiving the encryption key from a certificate authority; and
storing the encryption key in the memory.

23. The method of claim 21, wherein the encryption key is a private key of an asymmetric key pair.

24. The method of claim 23, further comprising:
assigning a public key corresponding to the private key to be a serial number for the positioning device.

25. The method of claim 21, further comprising:
assigning a serial number for the positioning device to comprise a decryption key corresponding to the encryption key.

26. A method of making offers, comprising:
receiving digitally signed position data;
first validating the digitally signed position data; and
if the first validating indicates validity, then making an offer based on the received digitally signed position data.

27. The method of claim 26, further comprising:
identifying that the position data has been edited by an editor and signed by an encryption key associated with the editor;
second validating the position data with a decryption key corresponding to the encryption key; and
if the second validating indicates validity, then making the offer.

28. The method of claim 25, wherein the first validating comprises:
identifying a serial number of a positioning device that digitally signed the position data;
determining a verification key based at least in part on the serial number; and
utilizing the verification key to validate the digitally signed position data.

29. An article, comprising:
a machine-accessible media having associated data, wherein the data, when accessed, results in a machine performing
determining a position data based at least in part on received signals from one or more signal sources,
digitally signing the position data, and
providing the digitally signed position data to a service provider configured to offer goods or services based at least in part on digitally signed position data.

30. The article of claim 29, wherein the machine-accessible media further comprises data, when accessed, results in the machine performing:
retrieving the positioning data from a positioning device;
retrieving an encryption key from the positioning device with which to digitally sign the position data.

31. The article of claim 30, wherein the machine-accessible media further comprises data, when accessed, results in the machine performing:
receiving the encryption key from a manufacturer of the positioning device; and
storing the encryption key in a memory associated with the positioning device.
